(19) United States
(12) Patent Application Publication
(10) Pub. No.: US 2023/0349608 A1
(43) Pub. Date: Nov. 2, 2023

(54) ANOMALY DETECTION FOR REFRIGERATION SYSTEMS

(71) Applicant: Fortive Corporation, Everett, WA (US)

(72) Inventors: Carter DeCew Tiernan, Pittsburgh, PA (US); Basant Singhatwadia, Eden Prairie, MN (US); Rosemary Elaine Pekarek, Plymouth, MN (US)

(21) Appl. No.: 17/733,624

(22) Filed: Apr. 29, 2022

(51) Int. Cl. F25B 49/00

(52) U.S. Cl. CPC F25B 49/00; F25B 2700/21; F25B 2500/06

(57) ABSTRACT

In various embodiments, a process for providing anomaly detection for refrigeration systems includes receiving telemetry data of one or more refrigeration systems, including measured temperature values and setpoint temperature values; processing the telemetry data to determine machine learning input data based at least in part on at least a portion of the measured temperature values and at least a portion of the setpoint temperature values; and using one or more hardware processors to apply the machine learning input data to a trained anomaly detection machine learning model to determine periodic anomaly metrics. The process provides an automatically determined indication based at least in part on at least a portion of the periodic anomaly metrics.

### BACKGROUND OF THE INVENTION

Refrigeration systems typically require periodic maintenance in order to function as desired. Typical service plans are reactive maintenance, which is performed when the system fails; planned preventative maintenance, which is performed according to a schedule regardless of the system's health; and condition-based maintenance, which is based on an assessment of the system's current functional health. However, conventional techniques typically result in loss of productivity or unplanned expenses because failures are caught too late or more maintenance is performed than is necessary. For example, conventional condition-based maintenance schedules typically have many false positives and do not take into account the nuances of refrigeration systems.

### BRIEF DESCRIPTION OF THE DRAWINGS

Various embodiments of the invention are disclosed in the following detailed description and the accompanying drawings.

FIG. 1 is a flow diagram illustrating an embodiment of a process for anomaly detection for refrigeration systems.

FIG. 2 is a block diagram illustrating an embodiment of a system for anomaly detection for refrigeration systems.

FIG. 3A is a flow diagram illustrating an embodiment of a process for training an anomaly detection machine learning model.

FIG. 3B shows an example of data associated with training an anomaly detection machine learning model.

FIG. 4 shows an example of graphical user interface for remote monitoring of refrigeration systems.

FIG. 5A shows an example of a graphical user interface for anomaly detection for refrigeration systems.

FIG. 5B shows an example of a graphical user interface for anomaly detection for refrigeration systems.

FIG. 6 is a block diagram illustrating an embodiment of a system for remote monitoring of refrigeration systems.

FIG. 7 is a functional diagram illustrating a programmed computer system for anomaly detection for refrigeration systems in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Anomaly detection for refrigeration systems is disclosed. Refrigeration systems are also sometimes referred to herein as equipment. Some systems include a case in which products are kept at a desired temperature range. The disclosed techniques predict failure of equipment in advance based on the characteristics of the data collected from the equipment. The disclosed anomaly detection techniques are more accurate and precise than conventional techniques, and find application in various service plans/regimes including reactive maintenance, planned preventative maintenance, and predictive maintenance.

In one aspect, they allow for service level agreements (SLAs) to be adjusted (e.g., relaxed) by being able to predict failure with greater certainty and specificity with regard to time, among other things. If prediction of failure can only be made 12-24 hours prior to actual failure, then the SLA would need to be 12 hours or less in order to service the equipment prior to failure. The disclosed techniques allow failure to be predicted further in advance, so the SLA can be increased, giving a technician more time to service the equipment, and reducing the service charge. In other words, planned preventative maintenance schedules can be adjusted to save time and money. For example, the disclosed techniques predict with high confidence that the equipment will fail in the next three days, enabling the service level agreement (SLA) to be increased to three days.

In another aspect, schedules for planned preventative maintenance may be adjusted to reduce the frequency of service so that unnecessary maintenance trips and costs are not incurred. Scheduled maintenance can therefore be guided with greater confidence using the disclosed anomaly detection techniques.

Conventional anomaly detection techniques typically do not work well for refrigeration systems. One reason is that while conventional rule-based techniques monitor various aspects of equipment, they may miss some nuances of the behavior of refrigeration systems. Another reason is that generic anomaly detection techniques are not adapted to the characteristics of refrigeration systems. For example, in many refrigeration systems, the goal is to maintain a low temperature. However, there are defrost periods during which the refrigerator is circulating warm instead of cool air. As such, data may be noisy or otherwise difficult to process. As another example, anomaly detection based on work orders may be inaccurate because work orders are manually completed by a technician who services the equipment and thus have a wide range of variability and possibility of human error. A failure reason might not be fully captured by a work order because a single label is inadequate.

In various embodiments, a process for anomaly detection for refrigeration systems includes receiving telemetry data of one or more refrigeration systems, wherein the data includes measured temperature values and setpoint temperature values. As further described herein, the data may include state information (such as operating mode that defines if the case is defrosting or not), environmental information such as outdoor temperature, calculated fields such as “superheat” which defines the delta between the refrigerants boiling temperature and its actual temperature after the evaporator. The process includes processing the telemetry data to determine machine learning input data based at least in part on at least a portion of the measured temperature values and at least a portion of the setpoint temperature values. The process includes using one or more hardware processors to apply the machine learning input data to a trained anomaly detection machine learning model to determine periodic anomaly metrics. The process includes providing an automatically determined indication based at least in part on at least a portion of the periodic anomaly metrics. The disclosed techniques may be applied to any refrigeration system including remote multideck chillers. For example, the architecture of the disclosed anomaly detection machine learning model remains the same while the weights and features can be adapted to accommodate the expected behavior of a specific refrigeration system.

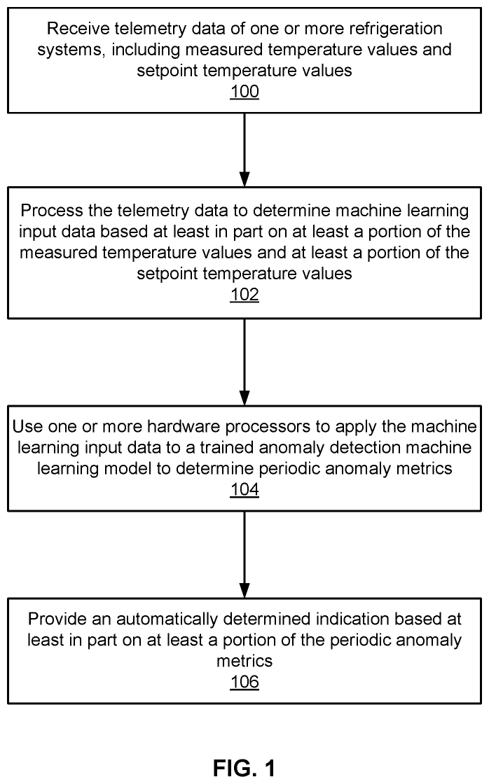

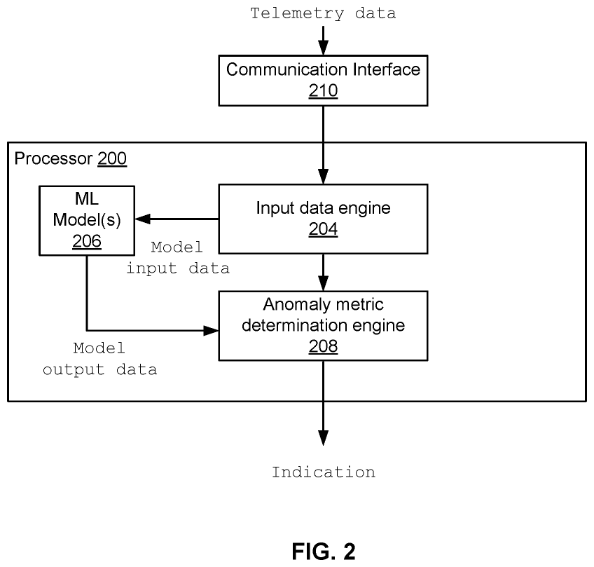

FIG. 1 is a flow diagram illustrating an embodiment of a process for anomaly detection for refrigeration systems. The process can be performed by a system such as the ones shown in FIG. 2, 6, or 7.

The process begins by receiving telemetry data of one or more refrigeration systems, including measured temperature values and setpoint temperature values (100). The telemetry data may be collected by one or more sensors that captures data associated with the refrigeration system(s) and transmits the data to a processing system via an API. For example, sensors may be included in or provided at various locations inside the refrigeration equipment such as within the case (e.g., at the air intake and output), outside the case (e.g., the evaporator inlet and outlet), or elsewhere in the system. Sensors may measure information external to the equipment, such as ambient condition/temperature of a store, characteristics of the environment in which the equipment is installed, weather characteristics, or the like. The temperature and setpoint temperature values may include or be accompanied by state information. In various embodiments, the telemetry data is collected periodically such as 15-minute intervals.

A setpoint value refers to a value that is only recorded when the value changes. The setpoint temperature value (also sometimes called cut in temperature) refers to a target temperature value, e.g., a case or cabinet setpoint. Typically, the air will turn on when the case temperature deviates from the setpoint temperature by more than a threshold value and the air will turn off when the case temperature deviates from the setpoint temperature by less than a threshold value.

In various embodiments, the telemetry data is collected periodically and continuously. The data can be processed by a long short-term memory (LSTM) autoencoder as further described herein. By way of non-limiting example, telemetry data includes one or more of the following:
Setpoint
Air off, temperature of the air entering the case
Air on, temperature of the air exiting the case
Case last defrost termination temperature, which is the temperature of the case at the end of the most recent defrost period
Superheat, which is a difference (delta) between the boiling point of the refrigerant (the substance used to cool the refrigerator) and its actual temperature after the evaporator
Weather temperature, which can be obtained periodically (e.g., hourly) of the outside (e.g., temperature or humidity) or other environment in which the refrigeration equipment resides (e.g., store ambient temperature)
Defrost state, which indicates whether the refrigeration system is in a defrost state or a refrigeration state and can be used to determine how long it takes to defrost
Operating mode, such as refrigeration, defrost, lockdown, fans only recovery, drop down

The process processes the telemetry data to determine machine learning input data based at least in part on at least a portion of the measured temperature values and at least a portion of the setpoint temperature values (102). In various embodiments, self-supervised machine learning is performed using the machine learning input data. The machine learning input data refers to features that can be input to a machine learning model for training.

The telemetry data can be processed in one or more of the following ways: encode categorical variables, forward fill missing values, determine relative values, or normalize values. Encoding categorical variables (e.g., defrost state and operating mode) refers to transforming variables from multiple distinct classes to numeric data with values that represent whether the category was seen (e.g., 1.0 is yes and 0.0 is no or any other class was seen). Forward filling refers to replacing null values with last seen values or 0.0. Relative values can be determined by subtracting each value by the setpoint temperature value, so the values are all relative deltas to the setpoint temperature value. Alternatively, temperature values can be processed to be a relative delta to some other reference value. Features can be normalized so their values are within the same bounds (e.g., between 1 and 0). Example normalization techniques include min-max and standard score. In various embodiments, the processing of air off, air on, case last defrost termination temperature, superheat, and weather temperature is performed in the following order: relative, normalize, forward fill; and/or the processing of defrost state and operating mode is transforming categorical variables then filled with 0.

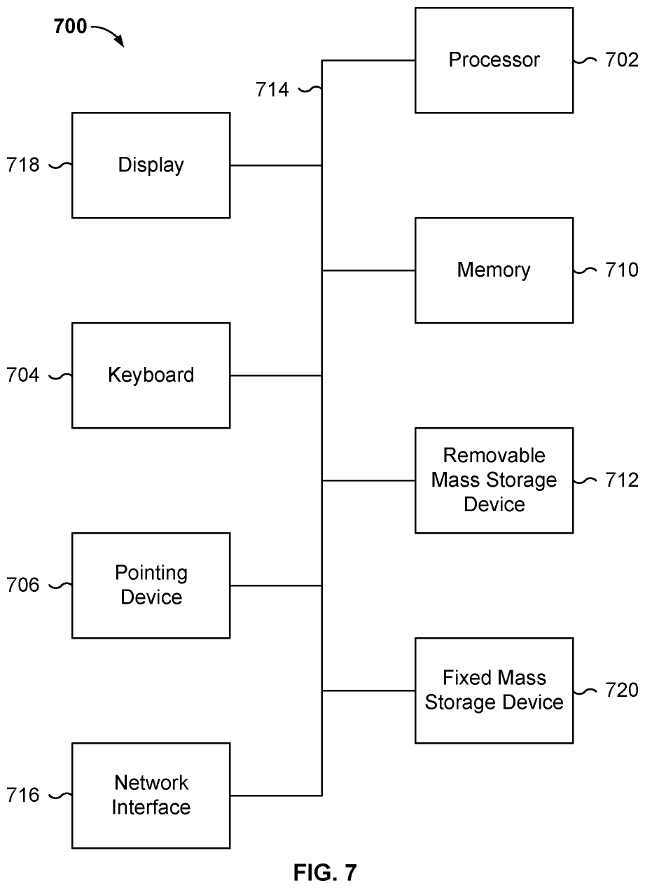

The process uses one or more hardware processors to apply the machine learning input data to a trained anomaly detection machine learning model to determine periodic anomaly metrics (104). An example of a hardware processor to apply the machine learning is shown in FIG. 7. In various embodiments, periodic anomaly metrics include one or more of the following: an anomaly score or an anomaly count. Alerts are generated via the anomaly metrics or rules based systems and may include messages indicating an operating state or characteristic such as information about various aspects of how a refrigeration system is operating. In various embodiments, the process generates an anomaly alert when the anomaly score exceeds a positive threshold defining the acceptable level of unusualness of the input data (the received telemetry data for example) for an extended period of time (where the period of time can be defined by a threshold). The amount of time anomalous behavior must be sustained to generate an alert is defined as a threshold to the anomaly count, which is calculated based on the anomaly score over time. The anomaly alert can be validated to be correlated with failure during model training by using work order, alarm data, or the like.

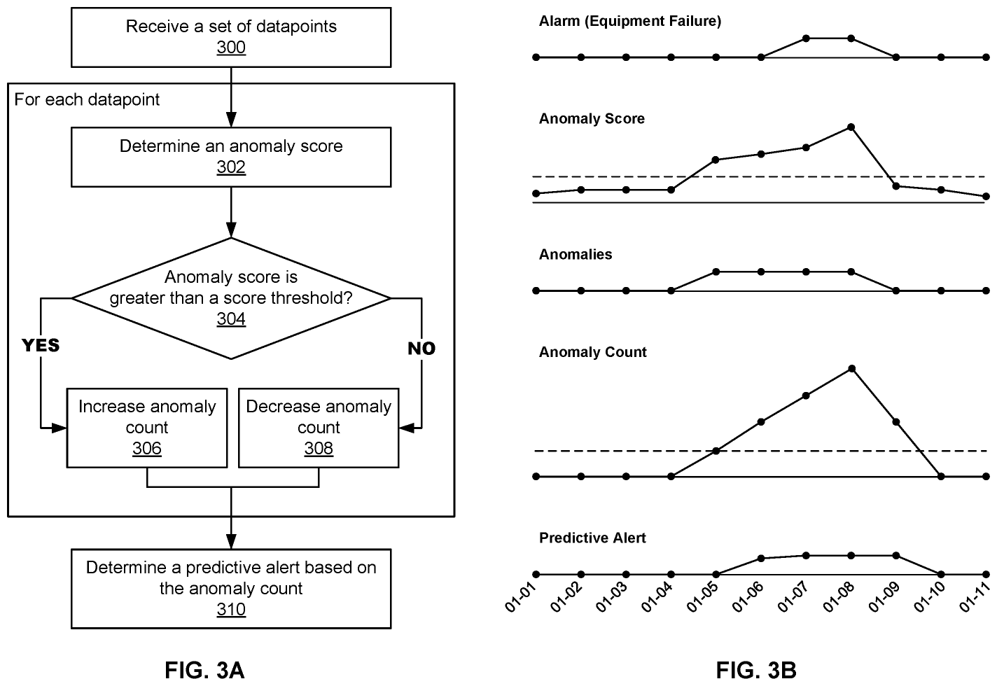

In various embodiments, the anomaly detection machine learning model is trained using self-supervised learning. For example, the anomaly detection machine learning model includes an autoencoder. An autoencoder includes an encoder network that transforms input data (e.g., telemetry, weather, and operating state data) into a latent space and a decoder network that learns to recreate the input data from the latent space representation. The mean absolute difference between the input and output of the model is an anomaly metric. An example of a process to train the anomaly detection machine learning model is further described with respect to FIG. 3A.

The process provides an automatically determined indication based at least in part on at least a portion of the periodic anomaly metrics (106). The indication can be automatically determined by categorizing an anomaly metric. For example, if an anomaly metric is above a threshold, the process determines that equipment failure is imminent (within some threshold failure time) and generates an indication. The indication may include details such as location of equipment, expected time to failure, specific locations or parts within the equipment that caused the indication to be generated, etc.

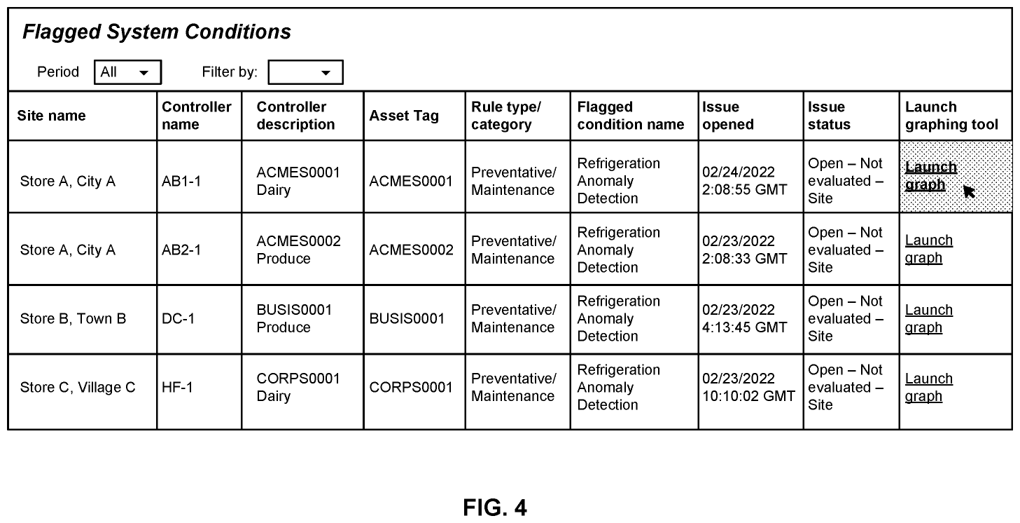

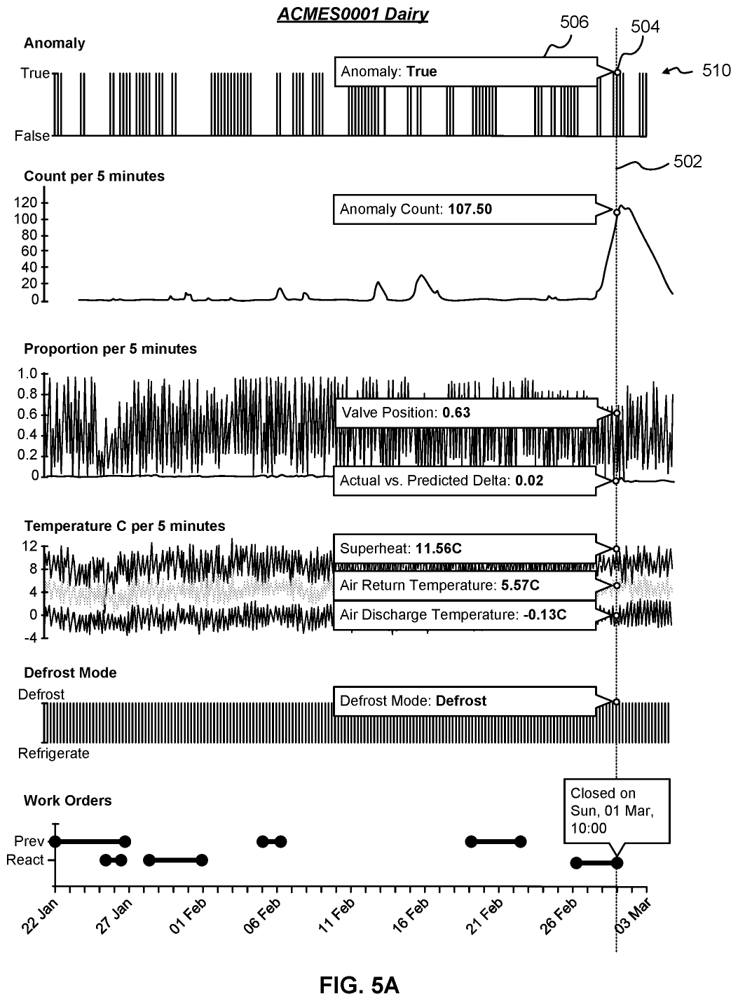

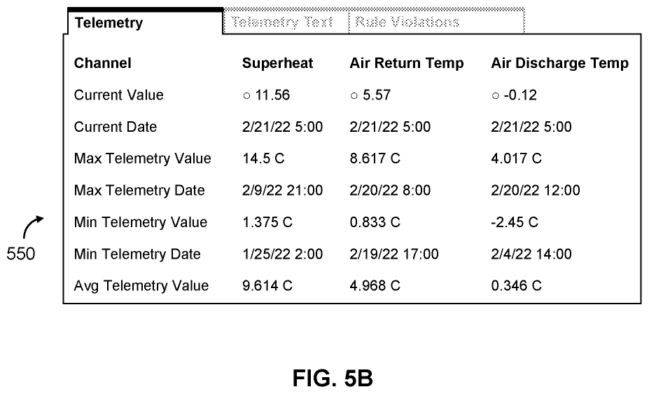

In various embodiments, the indication is output to a user interface such as a diagnostic tool, some examples of which are described with respect to FIGS. 4-5B. For example, the indication is provided on a graph such as the ones further described with respect to FIG. 5A. An analyst or technician can quickly and easily determine what caused equipment failure by looking at the indication. For example, when completing a work order, a technician can refer to the indication to determine what work needs to be done to service the equipment.

FIG. 2 is a block diagram illustrating an embodiment of a system for anomaly detection for refrigeration systems. The system includes a communication interface 210 and processor 200. The communication interface can be separate from the processor as shown or can be included in the processor. The communication interface can be implemented by a variety of hardware and/or software such as a network interface card. The communication interface is configured to receive telemetry data of one or more refrigeration systems including measured temperature values and setpoint temperature values.

Processor 200 includes an input data engine 204 and an anomaly metric determination engine 208. In various embodiments, processor 200 includes one or more machine learning models 206. Alternatively, one or more machine learning models can be remote from the processor and interact with the processor as described herein to provide input and output.

Input data engine 204 is configured to process telemetry data to determine machine learning input data based at least in part on at least a portion of the measured temperature values and at least a portion of the setpoint temperature values.

Anomaly metric determination engine 208 is configured to use one or more hardware processors to apply the machine learning input data to a trained anomaly detection machine learning model (206) to determine periodic anomaly metrics. In various embodiments, the anomaly detection machine learning model(s) 206 are trained using the process of FIG. 3A. Anomaly metric determination engine 208 is configured to provide an automatically determined indication based at least in part on at least a portion of the periodic anomaly metrics.

In operation, the system shown in FIG. 2 is configured to perform the process of FIG. 1 by receiving telemetry data via communication interface 210. Input data engine 204 processes the telemetry data by transforming categorical variables, forward filling, determining relative values, and/or normalizing values to generate model input data. The model input data is processed by trained machine learning models 206 to produce model output data for processing by anomaly metric determination engine 208. Anomaly metric determination engine 208 determines one or more metrics. The metrics or an associated indication is output by processor 200.

In various embodiments, the system of FIG. 2 can be implemented by infrastructure equipped to handle big data such as a Hadoop® Distributed File System (HDFS) to store collected telemetry data, Spark® to process the data for model training, and Kubernetes® to orchestrate automation of the deployment, scaling, and management. A Tensorfiow® model can be built to process a data stream (e.g., data in daily batches).

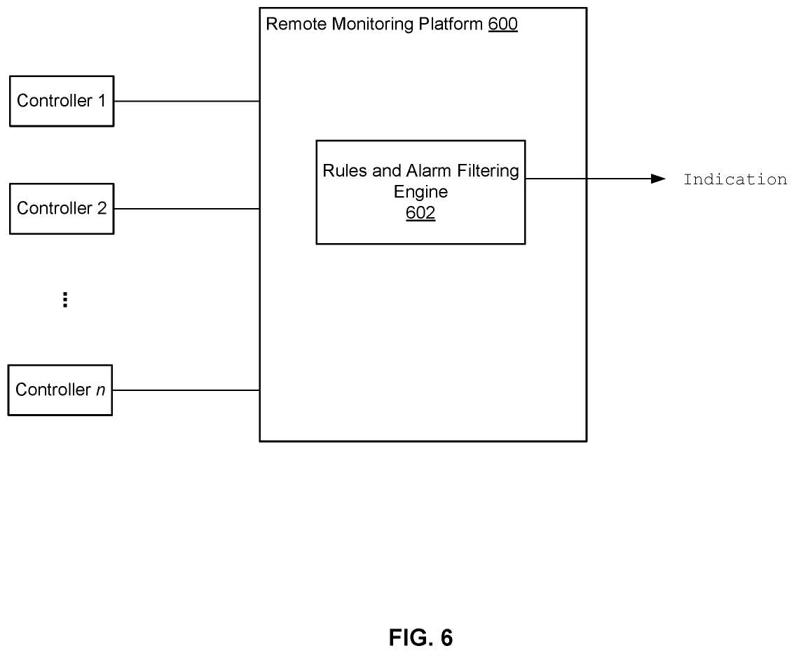

FIG. 3A is a flow diagram illustrating an embodiment of a process for training an anomaly detection machine learning model. The process can be performed by a system such as the one shown in FIGS. 2, 6, or FIG. 7. The process of FIG. 3A will be explained with the aid of FIG. 3B. In this example, the machine learning model is self-supervised, meaning it does not need label data. Past equipment failures can be collected to validate the model. The time-dependent temperature data also correspond to known operating modes (e.g., refrigeration cycles), which may provide another layer of validation. An LSTM learns a function representing the data distribution, and thus learns the nuances of refrigeration systems. For example, the LSTM learns that during a given time there are defrost periods, which are not necessarily equipment failures although they appear to be anomalous to an untrained model.

FIG. 3B shows an example of data associated with training an anomaly detection machine learning model. The top graph shows an actual alarm (equipment failure) in this example. The datapoints are collected over a time period ranging from January 1 (01-01) to January 11 (01-11). Here, the equipment fails beginning on January 7. The disclosed techniques can be applied to generate a predictive alert (bottom graph) without knowing the actual alarm.

Returning to FIG. 3A, the process begins by receiving a set of datapoints (300). For each datapoint, the process proceeds as follows. The process determines an anomaly score (302). In this example, the datapoints are collected over a time period ranging from January 1 (01-01) to January 11 (01-11). An anomaly score is determined for each datapoint. Referring to FIG. 3B, the anomaly score rises between January 4 and January 8 and falls after that date. As described herein, the anomaly score indicates unusualness of data and is a difference between the input and output of a machine learning model. In various embodiments, the anomaly score can be determined based on historical scores. For example, the process analyzes the characteristics of a datapoint, metadata, and historical patterns to calculate the anomaly score for a given datapoint. A score threshold is represented by the dashed line.

Returning to FIG. 3A, the process determines whether an anomaly score is greater than a score threshold (304). The score threshold can be selected based on a desired level of sensitivity of the system to reduce the number of false positives or false negatives to an acceptable level. If the anomaly score is greater than the score threshold, the process proceeds to increase the anomaly count (306). Otherwise, if the anomaly score is not greater than the score threshold, the process decreases the anomaly count (308). In other words, the process determines whether to update an anomaly count based on whether the anomaly score meets a score threshold.

Referring to FIG. 3B, the values on January 5 through January 8 exceed the threshold, so they are counted as anomalies, as shown in the anomalies graph. The anomaly count graph shows a running count of the number of anomalies seen so far. A count threshold is represented by the dashed line, so if the running count exceeds the count threshold, then a predictive alert is generated for that datapoint.

The process determines a predictive alert based on the anomaly count (310). In various embodiments, a predictive alert is generated if the anomaly count exceeds a count threshold. The count threshold can be set to account for the characteristics of refrigeration systems or even specific models of refrigeration systems such as periods of defrost that do not indicate equipment failure. For example, short periods of anomalies (e.g., anomalous temperature) could simply indicate re-stocking and not equipment failure.

Referring to FIG. 3B, between January 6 and January 9, the anomaly count exceeds the threshold, so a predictive alert is generated on those days. Thus, the predictive alert begins on January 6, which accurately predicts failure in advance of actual equipment failure.

FIG. 4 shows an example of graphical user interface for remote monitoring of refrigeration systems. The graphical user interface (GUI) can be displayed when a user accesses a remote monitoring system or platform such as vxObserve by Accruent®. The GUI allows a user to navigate through various flagged system conditions (alerts). For example, the information can be sorted by time using the “Period” menu or filtered by various filters.

Each row in the table corresponds to an issue (flagged condition) and columns show aspects of the issue. The columns are merely exemplary and not intended to be limiting as different or additional aspects can be displayed. In this example, the following information corresponding to each issue is displayed: site name, controller name, controller description, asset tag, rule type or category, flagged condition name, time when issue was opened, the status of the issue, and a link to launch a graphing tool. Other information such as issue time, security description, fixture ID, system component, and alarm status can be displayed.

Selecting the link to launch a graphing tool causes a user interface such as the ones shown in FIGS. 5A and 5B to be displayed. FIGS. 5A and 5B show user interfaces that are displayed in response to selecting the link for the first row, which corresponds to the controller ACMES0001 Dairy.

FIG. 5A shows an example of a graphical user interface for anomaly detection for refrigeration systems. The graphical user interface shows anomalies 510 detected for a controller (here, ACMES0001) along with other variables (also sometimes referred to as “refrigeration-dependent data”). In this example, the other variables include Count per 5 Minutes, Proportion per 5 Minutes, Temperature per 5 Minutes, Defrost Mode, and Work Orders. The variables that are shown along with “Anomaly” are merely exemplary and not intended to be limiting. Other variables besides the examples discussed herein may be shown instead or in addition to the ones shown in FIG. 5A. In this example, each graph shows a unit of measure and data for that unit of measure is plotted on that graph.

In various embodiments, a user can interact with the user interface to display details and other information. For example, the x-axis is time, and a user can move a bar 502 along the x-axis to display information at that point in time. The value of a variable at that time is indicated by a circle. For “Anomaly,” the value 504 at (Time 01 March) is “True,” which is also displayed in box 506. Similarly, the value for “Count per 5 Minutes” is 107.50. Several values can be plotted in a single graph, as shown in “Proportion per 5 Minutes” and “Temperature C per 5 Minutes,” and each value has a corresponding box. Additional information can be displayed in the box such as Fixture ID, Controller Name, Asset Tag, System Component, Equipment Type, or the like.

“Count per 5 Minutes” shows a rolling count of anomalous periods. If a period is anomalous, then a value is added to the rolling count. If a period is not anomalous, then a value is decremented from the rolling count. For example, the value can be 1 if there are any anomalies in that period, or the value can be the number of anomalies within that period.

“Proportion per 5 Minutes” shows percentages. The valve position determines how much refrigerant is introduced. In the graph, a valve position of 1.0 means that valve is fully open, a valve position of 0.0 means the valve is fully closed, and a value between 0 and 1 is some intermediate position. Also plotted on this graph is the actual difference between temperatures vs. the predicted difference between temperatures in percentages. In this example, the difference in temperature is conveniently shown as a percentage although it need not be strictly a percentage, e.g., the value can be unbounded.

“Temperature C per 5 Minutes” shows the temperature (in Celsius) measured every five minutes. In this example, several temperatures are shown: superheat, which is a delta between the boiling point of the refrigerant (used to cool the refrigerator) and its actual temperature after the evaporator; air return temperature which is the temperature at the air return valve; and air discharge temperature, which is the temperature at the air discharge valve.

“Defrost Mode” shows whether the equipment is in defrost mode or refrigeration mode. In this example, the equipment periodically and regularly defrosts throughout the day.

“Work Orders” shows work orders over time. A line represents the duration of the work order, the left endpoint of the line representing when the work order was opened and the right endpoint of the line representing when the work order was closed. In this example, different categories of work orders are listed on the y-axis of the graph, the two categories being preventative maintenance (“Prey”) and reactive maintenance (“React”). The preventative maintenance work orders are opened at regular intervals, here every 14 days. The reactive maintenance work orders are opened when equipment fails or is about to fail. Hovering over parts of graph may cause additional information to be displayed. For example, here the bar 502 shows that a reactive work order was closed on Sunday, 1 March at 10:00. Although not shown, additional information such as the priority of work order (low, medium, high for example) can be presented on the graph.

FIG. 5B shows an example of a graphical user interface for anomaly detection for refrigeration systems. In this example, telemetry data is displayed in panel 550. In various embodiments, the panel can be displayed together with the graphs shown in FIG. 5A. For example, panel 550 is displayed as an overlay, pop-up, or next to the graphs shown in FIG. 5A. This enables more detailed telemetry data to be shown to a user without cluttering the graphs. In this example, three tabs (“Telemetry,” “Telemetry Text,” and “Rule Violations”) can be selected to display corresponding information. The values correspond to the point in time of bar 502. Thus, moving bar 502 causes the values to be updated in real time in the display.

FIG. 6 is a block diagram illustrating an embodiment of a system for remote monitoring of refrigeration systems. The system of FIG. 2 can be implemented by or included in platform 600. The graphical user interfaces shown in FIGS. 4, 5A and 5B can be displayed when a user accesses remote monitoring platform 600. An example of a remote monitoring system is vxObserve by Accruent®.

The system includes a remote monitoring platform 600 configured to determine and output predictive alerts about equipment being monitored by the platform. The platform can monitor equipment such as refrigeration systems via controllers (here, Controller 1 through Controller n). Each controller represents an IoT device (e.g., sensor, channel, device, or controller). For example, a temperature sensor in a refrigeration case is represented as a Controller. In various embodiments, the controllers support singular, grouped, and global setpoint and schedule changes. The controller interacts with Platform 600 via APIs.

The remote monitoring platform 600 includes a Rules Engine and Alarm Filtering Engine 602. Engine 602 is configured to perform the process of FIG. 1 to determine predictive rules. Engine 602 is configured to output flagged conditions (alerts), which alert a user to potential issues for which to take action. The flagged conditions can be routed to an appropriate group or user based on issue and severity. The flagged conditions can be output to a dashboard or user interface, an example of which is shown in FIG. 4. A refrigeration anomaly can be output as an indication on the dashboard or user interface.

FIG. 7 is a functional diagram illustrating a programmed computer system for anomaly detection for refrigeration systems in accordance with some embodiments. As will be apparent, other computer system architectures and configurations can be used to perform anomaly detection for refrigeration systems. Computer system 700, which includes various subsystems as described below, includes at least one microprocessor subsystem (also referred to as a processor or a central processing unit (CPU)) 702. For example, processor 702 can be implemented by a single-chip processor or by multiple processors. In some embodiments, processor 702 is a general-purpose digital processor that controls the operation of the computer system 700. Using instructions retrieved from memory 710, the processor 702 controls the reception and manipulation of input data, and the output and display of data on output devices (e.g., display 718). In some embodiments, processor 702 includes and/or is used to executes/perform the process described below with respect to FIG. 7.

Processor 702 is coupled bi-directionally with memory 710, which can include a first primary storage, typically a random-access memory (RAM), and a second primary storage area, typically a read-only memory (ROM). As is well known in the art, primary storage can be used as a general storage area and as scratchpad memory, and can also be used to store input data and processed data. Primary storage can also store programming instructions and data, in the form of data objects and text objects, in addition to other data and instructions for processes operating on processor 702. Also as is well known in the art, primary storage typically includes basic operating instructions, program code, data and objects used by the processor 702 to perform its functions (e.g., programmed instructions). For example, memory 710 can include any suitable computer-readable storage media, described below, depending on whether, for example, data access needs to be bi-directional or uni-directional. For example, processor 702 can also directly and very rapidly retrieve and store frequently needed data in a cache memory (not shown).

A removable mass storage device 712 provides additional data storage capacity for the computer system 700, and is coupled either bi-directionally (read/write) or uni-directionally (read only) to processor 702. For example, storage 712 can also include computer-readable media such as magnetic tape, flash memory, PC-CARDS, portable mass storage devices, holographic storage devices, and other storage devices. A fixed mass storage 720 can also, for example, provide additional data storage capacity. The most common example of mass storage 720 is a hard disk drive. Mass storage 712, 720 generally store additional programming instructions, data, and the like that typically are not in active use by the processor 702. It will be appreciated that the information retained within mass storage 712 and 720 can be incorporated, if needed, in standard fashion as part of memory 710 (e.g., RAM) as virtual memory.

In addition to providing processor 702 access to storage subsystems, bus 714 can also be used to provide access to other subsystems and devices. As shown, these can include a display monitor 718, a network interface 716, a keyboard 704, and a pointing device 706, as well as an auxiliary input/output device interface, a sound card, speakers, and other subsystems as needed. For example, the pointing device 706 can be a mouse, stylus, track ball, or tablet, and is useful for interacting with a graphical user interface.

The network interface 716 allows processor 702 to be coupled to another computer, computer network, or telecommunications network using a network connection as shown. For example, through the network interface 716, the processor 702 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 702 can be used to connect the computer system 700 to an external network and transfer data according to standard protocols. For example, various process embodiments disclosed herein can be executed on processor 702, or can be performed across a network such as the Internet, intranet networks, or local area networks, in conjunction with a remote processor that shares a portion of the processing. Additional mass storage devices (not shown) can also be connected to processor 702 through network interface 716.

An auxiliary I/O device interface (not shown) can be used in conjunction with computer system 700. The auxiliary I/O device interface can include general and customized interfaces that allow the processor 702 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 7 is but an example of a computer system suitable for use with the various embodiments disclosed herein. Other computer systems suitable for such use can include additional or fewer subsystems. In addition, bus 714 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving telemetry data of one or more refrigeration systems, including measured temperature values and setpoint temperature values;
processing the telemetry data to determine machine learning input data based at least in part on at least a portion of the measured temperature values and at least a portion of the setpoint temperature values;
using one or more hardware processors to apply the machine learning input data to a trained anomaly detection machine learning model to determine periodic anomaly metrics; and
providing an automatically determined indication based at least in part on at least a portion of the periodic anomaly metrics.

2. The method of claim 1, wherein the telemetry data is collected by one or more sensors associated with the one or more refrigeration systems.

3. The method of claim 2, wherein at least one of the one or more sensors is a component included in the one or more refrigeration systems.

4. The method of claim 2, wherein at least one of the one or more sensors is configured to measure an ambient condition external to the one or more refrigeration systems.

5. The method of claim 1, wherein the telemetry data is collected periodically and continuously.

6. The method of claim 1, wherein processing the telemetry data to determine the machine learning input data includes at least one of: transforming categorical variables, forward filling, determining relative values, or normalizing values.

7. The method of claim 1, wherein the periodic anomaly metrics includes at least one of: an anomaly score or an anomaly count.

8. The method of claim 7, further comprising generating an anomaly alert in response to the anomaly score exceeding a score threshold for a threshold period of time; wherein:
the threshold period of time is based at least in part on the anomaly count; and
the automatically determined indication is based at least in part on the generated anomaly alert.

9. The method of claim 1, wherein the anomaly detection machine learning model is trained using self-supervised learning.

10. The method of claim 1, wherein the anomaly detection machine learning model includes an autoencoder.

11. The method of claim 1, further comprising processing at least a portion of the periodic anomaly metrics including by categorizing an anomaly metric based at least in part on a threshold to predict a likelihood of an equipment failure within a threshold failure time.

12. The method of claim 1, wherein providing the automatically determined indication includes outputting the indication to a user interface of a diagnostic tool.

13. The method of claim 1, wherein providing the automatically determined indication includes outputting, on a user interface, anomaly data and refrigeration-dependent data.

14. The method of claim 13, wherein the refrigeration-dependent data includes work order data.

15. The method of claim 1, wherein the automatically determined indication is provided on a graph.

16. The method of claim 15, wherein providing the automatically determined indication includes displaying information associated with a user-selected point in time on the graph.

17. The method of claim 1, further comprising training the anomaly detection machine learning model including by:
receiving a set of datapoints;
for each datapoint in the set of datapoints:
determining an anomaly score, and
determining whether to update an anomaly count based on whether the anomaly score meets a score threshold; and
determining a predictive alert based at least in part on the anomaly count;
wherein the automatically determined indication is based at least in part on the predictive alert.

18. The method of claim 17, wherein determining the predictive alert based at least in part on the anomaly count includes generating the predictive alert in response to the anomaly count being above a count threshold.

19. A system, comprising:
a communication interface configured to receive telemetry data of one or more refrigeration systems, including measured temperature values and setpoint temperature values; and
a processor coupled to the communication interface and configured to:
process the telemetry data to determine machine learning input data based at least in part on at least a portion of the measured temperature values and at least a portion of the setpoint temperature values;
use one or more hardware processors to apply the machine learning input data to a trained anomaly detection machine learning model to determine periodic anomaly metrics; and
provide an automatically determined indication based at least in part on at least a portion of the periodic anomaly metrics.

20. A computer program product embodied in a non-transitory computer readable medium and comprising computer instructions for:
receiving telemetry data of one or more refrigeration systems, including measured temperature values and setpoint temperature values;
processing the telemetry data to determine machine learning input data based at least in part on at least a portion of the measured temperature values and at least a portion of the setpoint temperature values;
using one or more hardware processors to apply the machine learning input data to a trained anomaly detection machine learning model to determine periodic anomaly metrics; and
providing an automatically determined indication based at least in part on at least a portion of the periodic anomaly metrics.
